(19) United States
(12) Patent Application Publication
(10) Pub. No.: US 2026/0155139 A1
(43) Pub. Date: Jun. 4, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Tasuku Kitade, Tokyo (JP); Yutaka Uno, Tokyo (JP); Masanori Tsujikawa, Tokyo (JP)

(73) Assignee: NEC Corporation, Tokyo (JP)

(21) Appl. No.: 19/398,447

(22) Filed: Nov. 24, 2025

(30) Foreign Application Priority Data
Nov. 29, 2024 (JP) 2024-208602

(51) Int. Cl. G10L 15/10; G06F 40/242; G10L 15/16

(52) U.S. Cl. CPC G10L 15/10; G06F 40/242; G10L 15/16

(57) ABSTRACT

An information processing apparatus includes at least one memory storing instructions, and at least one processor configured to execute the instructions to acquire speech recognition text, input the speech recognition text and a prompt for detecting erroneous words in the speech recognition text to a first large language model, acquire the erroneous words, acquire one or more phoneme sequences of reading of each of the erroneous words, output word correction candidates, input the erroneous word, the word correction candidates, and a prompt for instructing to select a word correction candidate to replace the erroneous word to a second large language model, apply the word correction candidate to the speech recognition text, and output a result. The information processing apparatus, for example, can contribute to the support of decision-making based on speech recognition by improving the accuracy of speech recognition.

### INCORPORATION BY REFERENCE

This application is based upon and claims the benefit of priority from Japanese patent application No. 2024-208602, filed on Nov. 29, 2024, the disclosure of which is incorporated herein in its entirety by reference.

### TECHNICAL FIELD

The present disclosure relates to an information processing apparatus, an information processing method, and a non-transitory computer-readable medium.

### BACKGROUND ART

A speech recognition technology for automatically generating text from audio data of recorded human speech is known. An example of such a technology is a speech recognition technology described in, for example, “UCORRECT: An Unsupervised Framework for Automatic Speech Recognition Error Correction, ICASSP, 2023”.

### SUMMARY

“UCORRECT: An Unsupervised Framework for Automatic Speech Recognition Error Correction, ICASSP, 2023” discloses a speech recognition correction technology for detecting recognition errors in the speech recognition text obtained by converting audio data into a text, generating correction candidates for the recognition errors, and selecting a correction candidate determined to be most appropriate from the correction candidates. However, in the technology of “UCORRECT: An Unsupervised Framework for Automatic Speech Recognition Error Correction, ICASSP, 2023”, since the correction candidates are generated in accordance with the context, there is a case where the correction candidates for the recognition error cannot be appropriately generated in a case where the audio data is highly technical in content. That is, in the technical field, there is a possibility that the correction accuracy is not improved much.

The present disclosure has been made in view of the above problem, and one example object of the present disclosure is to provide a technology for accurately correcting recognition errors in the speech recognition text.

According to an example aspect of the present disclosure, there is provided an information processing apparatus including at least one memory storing instructions, and at least one processor configured to execute the instructions to acquire speech recognition text obtained by converting speech into a text, input the speech recognition text and a prompt for detecting speech recognition erroneous words in the speech recognition text to a first large language model, and acquire the erroneous words output from the first large language model, acquire one or more phoneme sequences of reading of each of the erroneous words, and output word correction candidates in which a normalized phoneme distance between two phonemes of the phoneme sequence is equal to or less than a predetermined threshold, and input the erroneous word, the word correction candidates output based on the erroneous word, and a prompt for instructing to select a word correction candidate to replace the erroneous word to a second large language model, apply the word correction candidate output from the second large language model to the speech recognition text, and output a result.

According to another example aspect of the present disclosure, there is provided an information processing method wherein a computer acquires speech recognition text obtained by converting speech into a text, inputs the speech recognition text and a prompt for detecting speech recognition erroneous words in the speech recognition text to a first large language model, and acquires the erroneous words output from the first large language model, acquires one or more phoneme sequences of reading of each of the erroneous words, and outputs word correction candidates in which a normalized phoneme distance between two phonemes of the phoneme sequence is equal to or less than a predetermined threshold, and inputs the erroneous word, the word correction candidates output based on the erroneous word, and a prompt for instructing to select a word correction candidate to replace the erroneous word to a second large language model, applies the word correction candidate output from the second large language model to the speech recognition text, and outputs a result.

According to still another example aspect of the present disclosure, there is provided a non-transitory computer-readable medium storing an information processing program causing a computer to execute processing, the processing including processing of acquiring speech recognition text obtained by converting speech into a text, processing of inputting the speech recognition text and a prompt for detecting speech recognition erroneous words in the speech recognition text to a first large language model, and acquiring the erroneous words output from the first large language model, processing of acquiring one or more phoneme sequences of reading of each of the erroneous words, and outputting word correction candidates in which a normalized phoneme distance between two phonemes of the phoneme sequence is equal to or less than a predetermined threshold, and processing of inputting the erroneous word, the word correction candidates output based on the erroneous word, and a prompt for instructing to select a word correction candidate to replace the erroneous word to a second large language model, applying the word correction candidate output from the second large language model to the speech recognition text, and outputting a result.

According to the example aspects of the present disclosure, there is an exemplary effect that a technology for accurately correcting the recognition error for the speech recognition text can be provided.

### BRIEF DESCRIPTION OF DRAWINGS

The above and other aspects, features, and advantages of the present disclosure will become more apparent from the following description of certain example embodiments in a case where taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a schematic diagram illustrating an example of a word reading dictionary according to the present disclosure;

FIG. 5 is a schematic diagram illustrating an example of a phoneme distance table according to the present disclosure;

FIG. 6 is a flowchart illustrating an example of information processing executed by an information processing apparatus according to the present disclosure;

FIG. 7 is a schematic diagram illustrating a method for generating a phoneme distance table using a trained machine learning model according to the present disclosure; and

FIG. 8 is a block diagram illustrating a configuration of a computer functioning as an information processing apparatus according to the present disclosure.

### EXAMPLE EMBODIMENT

Hereinafter, example embodiments of the present disclosure will be described. However, the present disclosure is not limited to the following exemplary example embodiments, and various modifications can be made within a scope described in the claims. For example, example embodiments obtained by appropriately combining technologies (some or all of things or methods) adopted in the following exemplary example embodiments can also be included in the scope of the present disclosure. Example embodiments obtained by appropriately omitting some of the technologies adopted in the following exemplary example embodiments can also be included in the scope of the present disclosure. Effects mentioned in the following exemplary example embodiments are examples of effects expected in the exemplary example embodiments, and do not define extension of the present disclosure. In other words, example embodiments that do not provide the effects mentioned in each of the following exemplary example embodiments can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in the drawings referred to for describing the present exemplary example embodiment can also be adopted in other exemplary example embodiments included in the present disclosure within a range in which no particular technical problem occurs.

### Configuration of Information Processing Apparatus

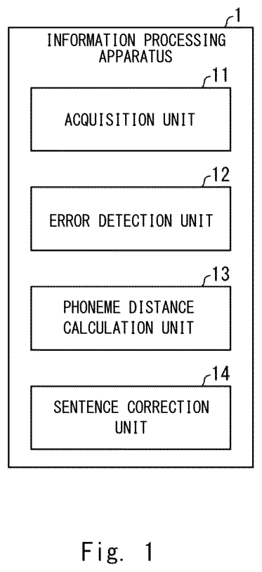

A configuration of an information processing apparatus 1 will be described with reference to FIG. 1. FIG. 1 is a block diagram illustrating a configuration of the information processing apparatus 1. The information processing apparatus 1 is an apparatus that detects recognition errors of speech recognition text obtained by converting audio data into a text and outputs a correct speech recognition text. As illustrated in FIG. 1, the information processing apparatus 1 includes an acquisition unit 11 (acquisition means in the claims), an error detection unit 12 (error detection means in the claims), a phoneme distance calculation unit 13 (phoneme distance calculation means in the claims), and a sentence correction unit 14 (sentence correction means in the claims). Hereinafter, each unit of the information processing apparatus 1 will be described.

The acquisition unit 11 acquires a speech recognition text obtained by converting speech into a text. The speech recognition text can be generated from data recorded with speech using a known technology. The speech recognition text (hereinafter, also simply referred to as “text”) may be recorded in any memory or database, and the acquisition unit 11 may acquire the speech recognition text recorded in advance and record the speech recognition text in the memory of the information processing apparatus 1. Alternatively, the acquisition unit 11 may generate speech recognition text from the audio data using a program for generating the speech recognition text from the audio data, record the speech recognition text in the memory of the information processing apparatus 1, and acquire the speech recognition text.

The error detection unit 12 inputs the speech recognition text and a prompt for detecting speech recognition erroneous words in the speech recognition text to a first large language model, and acquires the erroneous words output from the first large language model. The large language model (LLM) is any existing neural network model trained using a large amount of language data. For this large language model, the error detection unit 12 inputs a prompt such as “Please extract erroneous words from the next sentence” along with the speech recognition text, such that the erroneous words (words considered to be incorrect) are output from the large language model based on portions where the context is inconsistent, and the like. The error detection unit 12 acquires the output erroneous words.

The phoneme distance calculation unit 13 acquires one or more phoneme sequences for the reading of each of the erroneous words, and outputs word correction candidates in which a normalized phoneme distance between two phonemes of the phoneme sequence is equal to or less than a predetermined threshold. In a case where the speech recognition text is Japanese, the erroneous words may be not only the words (Kanji characters, hiragana, katakana, and the like) but also a katakana sequence or a character string that is not a word. In a case where the speech recognition text is English, the erroneous word is a single alphabetical word. The phoneme distance calculation unit 13 acquires one or more phoneme sequences for the reading of such an erroneous word. In a case where there are a plurality of reading ways for Kanji characters, the phoneme distance calculation unit 13 acquires a plurality of reading ways. The phoneme distance calculation unit 13 outputs word correction candidates in which a normalized phoneme distance between two phonemes of the acquired phoneme sequence is equal to or less than a predetermined threshold. A phoneme is the smallest unit of sound that corresponds to a consonant or a vowel. Therefore, it is not the same as a syllable. For example, the vowel phonemes are a, i, u, e, and o, and the consonant phonemes are k (K-row), s (S-row), and t (T-row). It also includes nasal sounds and geminate consonants. Punctuation marks may be regarded as silent phonemes. The phoneme distance is an index that represents the ease of recognizing the difference between two phonemes. For example, the larger the phoneme distance, the greater the difference, and it is thus determined to be a phoneme that is less likely to be mistaken. Therefore, a word correction candidate including a phoneme sequence in which the sum of the normalized phoneme distances is equal to or less than a predetermined threshold is selected and output. The “normalization” refers to, for example, dividing the total value of the phoneme distances by the number of phonemes. Since a word is composed of a plurality of phonemes, the sum of phoneme distances also increases as the length of the word increases. Therefore, by dividing the total value of the phoneme distances by the number of phonemes, the phoneme distances that can be compared between words can be obtained.

The sentence correction unit 14 inputs an erroneous word, word correction candidates output based on the erroneous word, and a prompt for instructing to select a word correction candidate to replace the erroneous word to a second large language model, applies the word correction candidate output from the second large language model to the speech recognition text, and outputs the speech recognition text. The sentence correction unit 14 generates a prompt such as “Please select a word for correcting the erroneous words in the text from among the word correction candidates” together with the speech recognition text, the erroneous words, and the word correction candidates that is output for the erroneous words, and inputs the prompt to the second large language model. The sentence correction unit 14 acquires the selected word output from the second large language model. The sentence correction unit 14 generates and outputs the corrected speech recognition text in place of the selected word. The first large language model and the second large language model may be the same large language model.

Alternatively, for example, the sentence correction unit 14 may generate a prompt such as “Please replace the erroneous words in the text with the most appropriate word correction candidates to create a correct text” in place of the above-described prompt, input the prompt to the second large language model, acquire the entire text of the output “correct text”, and output the entire text as the corrected text as it is.

### Effect of Information Processing Apparatus 1

As described above, the information processing apparatus 1 includes the acquisition unit for acquiring the speech recognition text obtained by converting the speech into a text, the error detection unit for inputting the speech recognition text and the prompt for detecting speech recognition erroneous words in the speech recognition text to the first large language model, and acquiring the erroneous words output from the first large language model, the phoneme distance calculation unit for acquiring one or more phoneme sequences of the reading of each of the erroneous words, and outputting word correction candidates in which a normalized phoneme distance between two phonemes of the phoneme sequence is equal to or less than a predetermined threshold, and the sentence correction unit for inputting the erroneous word, the word correction candidates output based on the erroneous word, and a prompt for instructing to select a word correction candidate to replace the erroneous word to the second large language model, applying a result output from the second large language model to the speech recognition text, and outputting the result. Therefore, in the information processing apparatus 1, it is possible to obtain an effect that the recognition error of the speech recognition text can be corrected with higher accuracy than in the related art by analyzing the phonemes of the recognition erroneous words.

### Flow of Information Processing Method

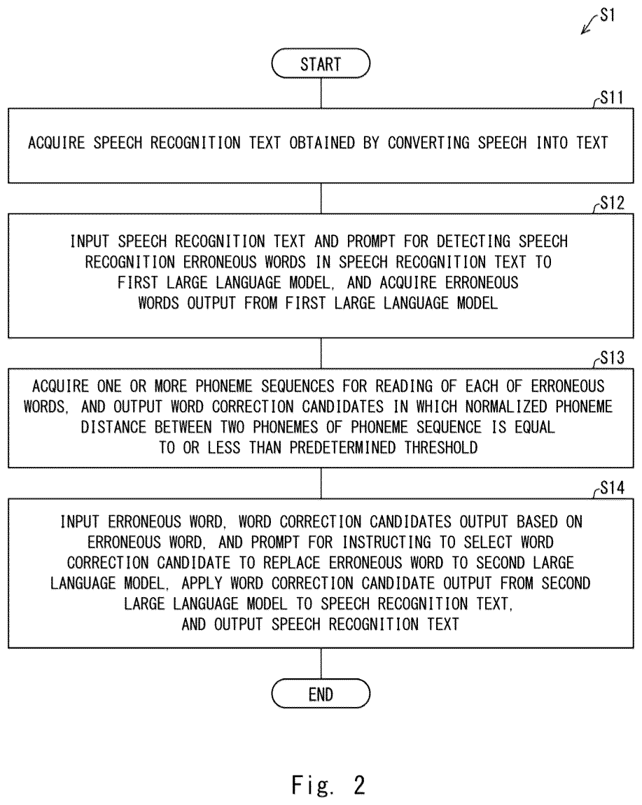

A flow of an information processing method S1 will be described with reference to FIG. 2. FIG. 2 is a flowchart illustrating the flow of the information processing method S1. As illustrated in FIG. 2, the information processing method S1 includes text acquisition processing S11, erroneous word acquisition processing S12, word correction candidate output processing S13, and corrected text output processing S14.

The text acquisition processing S11 is processing of acquiring speech recognition text obtained by converting speech into a text. The text acquisition processing S11 is executed by the acquisition unit 11 (one processor). The content of the text acquisition processing S11 is as described for the acquisition unit 11.

The erroneous word acquisition processing S12 is processing of inputting speech recognition text and a prompt for detecting speech recognition erroneous words in the speech recognition text to a first large language model, and acquires the erroneous words output from the first large language model. The erroneous word acquisition processing S12 is executed by the error detection unit 12 (one processor). The content of the erroneous word acquisition processing S12 is as described for the error detection unit 12.

The word correction candidate output processing S13 is processing of acquiring one or more phoneme sequences for the reading of each of the erroneous words, and outputting word correction candidates in which a normalized phoneme distance between two phonemes of the phoneme sequence is equal to or less than a predetermined threshold. The word correction candidate output processing S13 is executed by the phoneme distance calculation unit 13 (one processor). The content of the word correction candidate output processing S13 is as described for the phoneme distance calculation unit 13.

The corrected text output processing S14 is processing of inputting an erroneous word, word correction candidates output based on the erroneous word, and a prompt for instructing to select a word correction candidate to replace the error word to a second large language model, applying the word correction candidate output from the second large language model to the speech recognition text, and outputting the result. The corrected text output processing S14 is executed by the sentence correction unit 14 (one processor). The content of the corrected text output processing S14 is as described for the sentence correction unit 14.

### Effects of Information Processing Method

As described above, the information processing method S1 includes causing at least one processor execute the text acquisition processing of acquiring the speech recognition text obtained by converting the speech into a text, the erroneous word acquisition processing of inputting the speech recognition text and the prompt for detecting speech recognition erroneous words in the speech recognition text to the first large language model, and acquiring the erroneous words output from the first large language model, the word correction candidate output processing of acquiring one or more phoneme sequences of the reading of each of the erroneous words, and outputting word correction candidates in which a normalized phoneme distance between two phonemes of the phoneme sequence is equal to or less than a predetermined threshold, and the corrected text output processing of inputting the erroneous word, the word correction candidates output based on the erroneous word, and a prompt for instructing to select a word correction candidate to replace the erroneous word to the second large language model, applying the word correction candidate output from the second large language model to the speech recognition text, and outputting the speech recognition text. Therefore, in the information processing method S1, it is possible to obtain an effect that the recognition error of the speech recognition text can be corrected with higher accuracy than in the related art by analyzing the phonemes of the recognition erroneous words.

### Second Exemplary Example Embodiment

A second exemplary example embodiment that is an example of the example embodiments of the present disclosure will be described in detail with reference to the drawings. Components that have the same functions as the components described in the above-described exemplary example embodiment are denoted by the same reference signs, and will not be described as appropriate. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in each of the drawings referred to for describing the present exemplary example embodiment can also be adopted in another exemplary example embodiment included in the present disclosure within a range in which no particular technical problem occurs.

### Configuration of Information Processing Apparatus 1A

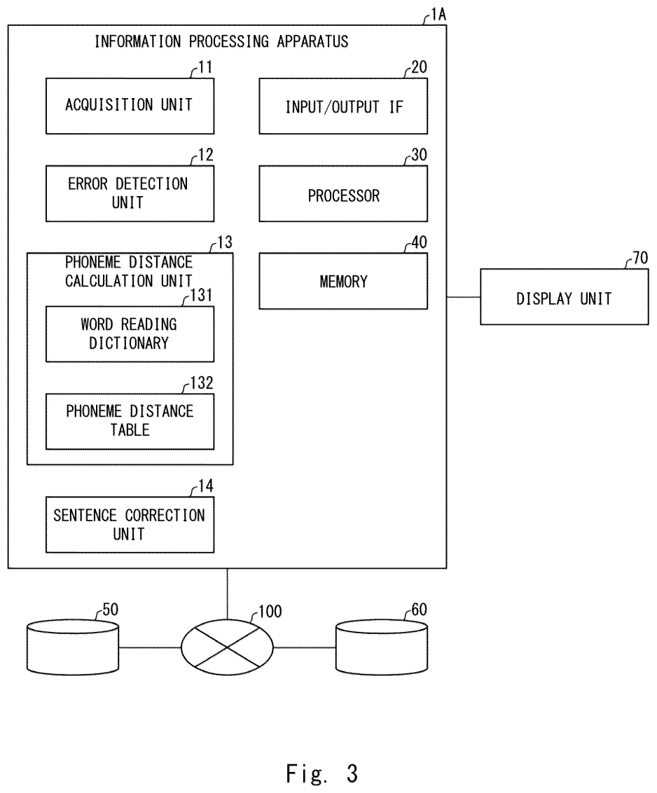

A configuration of an information processing apparatus 1A will be described with reference to FIG. 3. FIG. 3 is a block diagram illustrating the configuration of the information processing apparatus 1A. The information processing apparatus 1A includes an input/output interface (input/output IF) 20, at least one processor 30, and at least one memory 40 in addition to the acquisition unit 11, the error detection unit 12, the phoneme distance calculation unit 13, and the sentence correction unit 14 included in the information processing apparatus 1. The phoneme distance calculation unit 13 includes a word reading dictionary 131 and a phoneme distance table 132. The information processing apparatus 1A may be connected to a display unit (display) 70. Hereinafter, functions other than the functions of the information processing apparatus 1 described in the first exemplary example embodiment will be described for units of the information processing apparatus 1A.

The processor 30 can be configured using a general-purpose processor such as at least one micro processing unit (MPU) or a central processing unit (CPU). The processor 30 may include a dedicated processor including an application specific integrated circuit (ASIC), a field programmable gate array (FPGA), and a programmable logic device (PLD).

The memory 40 may include a plurality of types of memories such as a read only memory (ROM) and a random access memory (RAM). The memory 40 may include a built-in or external memory such as a hard disk drive (HDD) or a solid state drive (SSD). As an example, the processor 20 implements functions as the acquisition unit 11, the error detection unit 12, the phoneme distance calculation unit 13, and the sentence correction unit 14 by loading various control programs recorded in the ROM of the memory 40 into the RAM and executing the programs. Various programs and data such as speech recognition text may be recorded in a cloud database (not illustrated) or the like disposed outside.

The input/output IF 20 is an interface that transmits and receives data to and from the outside. Communication between the input/output IF 20 and the outside may be performed, for example, via the Internet 100. The input/output IF 20 may include, for example, a short-range communication apparatus such as WiFi (registered trademark) or Bluetooth (registered trademark), which can wirelessly connect to an Internet access point. A wired connection interface such as a USB connector may be used. For example, communication with a first large language model 50 and a second large language model 60 is performed via the Internet 100.

The error detection unit 12 may acquire information regarding the topic of the speech recognition text together with the erroneous word. The information regarding the topic may be a concept representing the topic or may be a word frequently appearing in the topic. The phoneme distance calculation unit 13 can narrow down the word correction candidates using the information regarding the topic. For example, in a case where a large number of word correction candidates are listed, for example, the phoneme distance calculation unit 13 may evaluate the degree of relevance of the word correction candidates to the topic and extract a word correction candidate with the highest relevance.

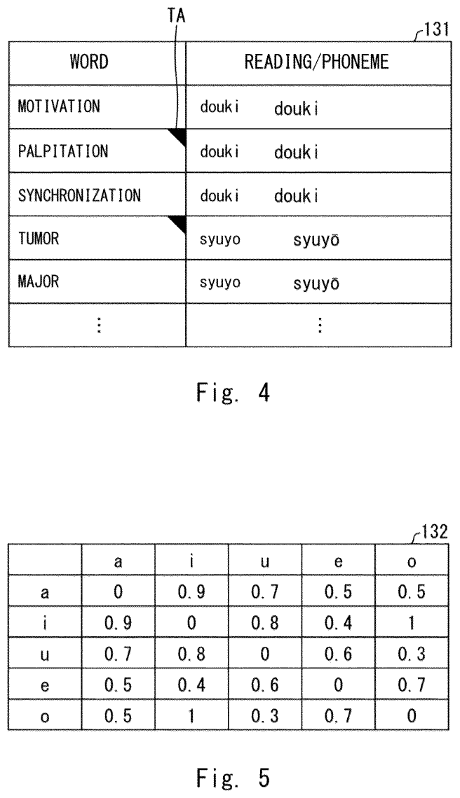

The phoneme distance calculation unit 13 acquires the phoneme sequence of the erroneous word using the word reading dictionary. An example of the word reading dictionary is illustrated in FIG. 4. The word reading dictionary 131 illustrated in FIG. 4 is a dictionary in which words (kanji) and their reading (or phoneme sequence) are associated with each other. In the word reading dictionary 131, for example, it is recorded that the reading of a word “motivation” (hiragana phoneme sequence) is “douki” in Japanese, and the phoneme sequence indicating the reading in the alphabet is “douki”. The same reading (phoneme sequence) is recorded for the words “palpitation” and “synchronization”. Only the word and one of the phoneme sequences may be recorded in the word reading dictionary 131.

The phoneme distance calculation unit 13 may derive the phoneme distance using the phoneme distance table in which the distance between two phonemes is defined. An example of the phoneme distance table is illustrated in FIG. 5. The phoneme distance table 132 shows a table in which the inter-phoneme distance for the phonemes of the “A-row” (a, i, u, e, and o) is recorded. For example, since the phonemes of “a” and “a” are the same, the phoneme distance is zero. The phoneme distance between “a” and “i” is 0.9. The phoneme distance is a numerical value between zero and one, and the closer the phoneme distance (the more similar the pronunciation), the smaller the numerical value. Note that there is also a table in which phoneme distances between phonemes in the “A” row and phonemes in the other rows are recorded, and there is also a similar table for phonemes other than the A-row.

In a case of outputting the word correction candidates, the phoneme distance calculation unit 13 selects and outputs a word correction candidate for which a numerical value indicating the smallest possible difference from the erroneous word is obtained. That is, the phoneme distance table 132 is a cost table, and a word including a combination of phonemes for which the cost calculated using the cost table is as low as possible is selected as the word correction candidate. The phoneme distance table 132 is created in advance.

The phoneme distance table 132 may be, for example, an inter-phoneme cost table created by a model trained using pair data of an erroneous word included in the recognition text of the speech acquired under a common condition and the corresponding correct word. The common condition refers to a condition in which a topic (domain), a recording environment (place, room, microphone, and the like) of audio data, a speech recognition model, and the like are similar or the same. The machine learning model is trained by using a large number of pieces of training data including the erroneous word and the correct word included in the speech recognition text of the audio data acquired under such a condition. Using the machine learning model trained in this way, the phoneme distance (cost) between any two phonemes can be evaluated and tabulated.

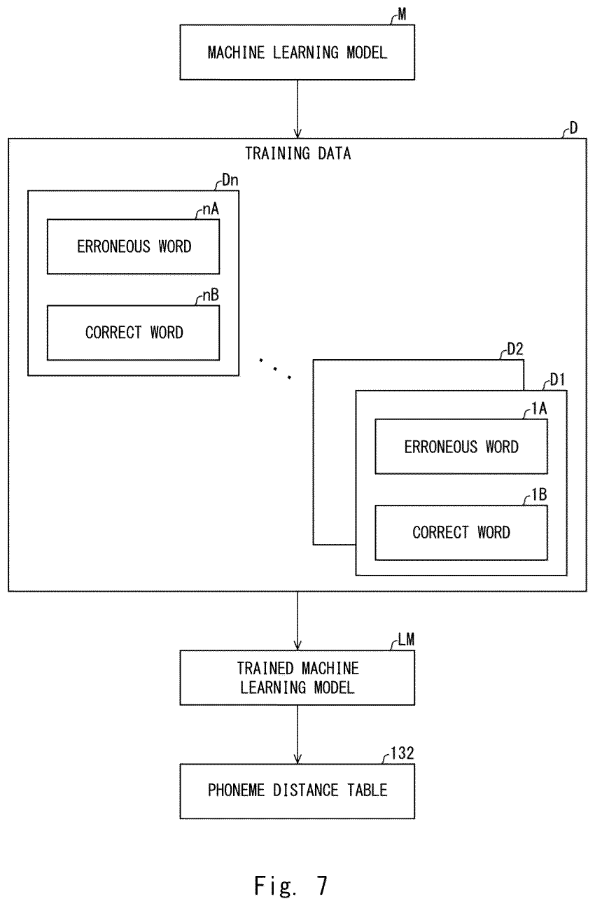

FIG. 7 is a schematic diagram illustrating a method for generating a phoneme distance table using a trained machine learning model. First, a dataset including an erroneous word 1A and a correct word 1B is set as pair D1. Training data D including n such pairs is input to the untrained machine learning model M for training. Such training is iterated to generate the trained machine learning model LM. The machine learning model M can be trained on the confusability (cost) between phonemes from a combination of phoneme sequences of an erroneous word and a correct word. The phoneme distance table output from the trained machine learning model LM can be used as the phoneme distance table 132 used by the phoneme distance calculation unit 13.

In a case where there is no word correction candidate in which the normalized phoneme distance is equal to or less than a predetermined threshold, the phoneme distance calculation unit 13 may output a word correction candidate having the smallest normalized phoneme distance from among the evaluated word correction candidates. Alternatively, a plurality of word correction candidates including the word correction candidate having the smallest normalized phoneme distance may be output.

The word reading dictionary may include technical term flags. Each of the technical term flags may be added by a user (expert), or may be added by using, for example, a technical term list of a field for targets collected in advance by the phoneme distance calculation unit 13 using an LLM or the like, or a publicly available technical term dictionary. In the word reading dictionary 131 illustrated in FIG. 4, flags TA, which indicate technical terms, are respectively added to the word “palpitation” and the word “tumor”. The word reading dictionary 131 is a dictionary for correcting errors of the speech recognition text in the medical field. Therefore, the flags TA are respectively added to the word “palpitation” and the word “tumor” as technical terms in the medical field. The phoneme distance calculation unit 13 may add a weight to the word to which the flag TA is added in obtaining the phoneme distance. Adding a weight indicates processing of increasing the evaluation value, and corresponds to performing processing of reducing the cost in the present exemplary example embodiment.

The sentence correction unit 14 may select a word correction candidate based on the information acquired by the error detection unit 12 using the second large language model generated by Retrieval-Augmented Generation. The Retrieval-Augmented Generation (RAG) is a method for accurately correcting errors in the speech recognition text related to a technical field by, for example, inputting technical term data to a large language model for retraining the large language model.

Specifically, the error detection unit 12 performs error detection using, for example, a general-purpose large language model tuned for medical use. The text region is narrowed down based on the remaining words that are not determined to be erroneous. For example, in a case where the error detection unit 12 can narrow down the content of the text to a clinical department, the error detection unit 12 transmits the information to the sentence correction unit 14. The sentence correction unit 14 selects a word correction candidate using the second large language model generated by Retrieval-Augmented Generation, which is restricted to the field of a “clinical department”. By such a method, it is possible to accurately correct errors in the speech recognition text.

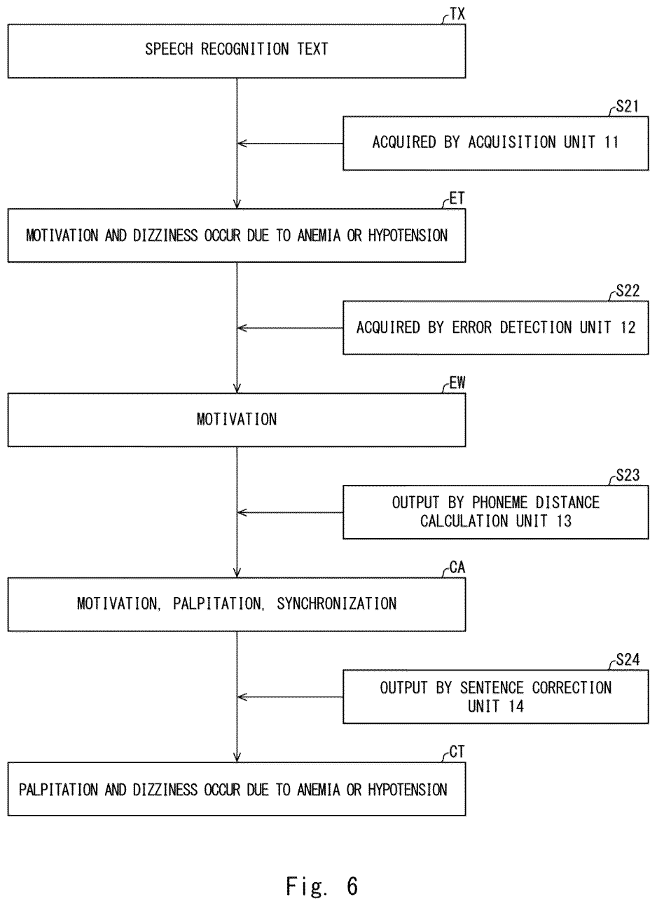

FIG. 6 is a flowchart illustrating an example of an information processing method S2 executed by the information processing apparatus 1A. First, the acquisition unit 11 acquires speech recognition text TX (step S21). It is assumed that there is a sentence “Motivation and dizziness occur due to anemia or hypotension” in the word correction candidate.

On the other hand, the error detection unit 12 acquires the phrase “motivation” (which reads “douki” in Japanese) as an erroneous word (step S22). Next, the phoneme distance calculation unit 13 acquires a phoneme sequence of the reading of “motivation”. For example, the phoneme distance calculation unit 13 acquires “douki” using the word reading dictionary 131 illustrated in FIG. 4. Next, the phoneme distance calculation unit 13 outputs word correction candidates in which a normalized phoneme distance between two phonemes of the phoneme sequence “douki” is equal to or less than a predetermined threshold. For example, three words of “motivation”, “palpitation”, and “synchronization” (which all the words read “douki” in Japanese) in which the sum of the phoneme distances is zero in the same reading are output (step S23). Next, the sentence correction unit 14 inputs these words together with the speech recognition text to the second large language model. “Palpitation and dizziness occur due to anemia or hypotension”, which is the correct text output from the second large language model, is acquired, the sentence of the original speech recognition text is replaced with the correct text, and the result is output (step S24).

### Effects of Information Processing Apparatus 1A

As described above, in the information processing apparatus 1A, a configuration in which the phoneme distance calculation unit 13 acquires the phoneme sequence of the erroneous word using the word reading dictionary is adopted. Therefore, in the information processing apparatus 1A, in addition to the effects obtained by the information processing apparatus 1, it is possible to obtain an effect that the correct phoneme sequence of the erroneous word can be efficiently acquired.

In the information processing apparatus 1A, a configuration is adopted in which the phoneme distance calculation unit 13 derives the phoneme distance using the phoneme distance table in which the distance between two phonemes is defined. Therefore, in the information processing apparatus 1A, in addition to the effects obtained by the information processing apparatus 1, it is possible to obtain an effect that the phoneme distance can be derived efficiently.

In the information processing apparatus 1A, a configuration is adopted in which the error detection unit 12 acquires information regarding the topic of the speech recognition text together with the erroneous word, and the phoneme distance calculation unit 13 narrows down the word correction candidate using the information. Therefore, in the information processing apparatus 1A, in addition to the effects obtained by the information processing apparatus 1, it is possible to obtain an effect that the word correction candidates can be accurately narrowed down.

In the information processing apparatus 1A, a configuration is adopted in which the sentence correction unit 14 selects a word correction candidate based on the information acquired by the error detection unit 12 using the second large language model generated by Retrieval-Augmented Generation. Therefore, in the information processing apparatus 1A, in addition to the effects obtained by the information processing apparatus 1, it is possible to obtain an effect that the word correction candidates can be more accurately selected.

In the information processing apparatus 1A, a configuration is adopted in which in a case where there is no word correction candidate in which the normalized phoneme distance is equal to or less than a predetermined threshold, the phoneme distance calculation unit 13 outputs a word correction candidate having the smallest normalized phoneme distance. Therefore, in the information processing apparatus 1A, in addition to the effects obtained by the information processing apparatus 1, it is possible to obtain an effect that the word correction candidate considered to be the most appropriate can be output even in a case where no word correction candidate satisfying a predetermined condition is found.

In the information processing apparatus 1A, a configuration is adopted in which technical term flags are added to the word reading dictionary 131, and the phoneme distance calculation unit 13 adds a weight to the word to which a flag is added in obtaining the phoneme distance. Therefore, in the information processing apparatus 1A, in addition to the effects obtained by the information processing apparatus 1, it is possible to obtain an effect that speech recognition text correction can be performed more accurately for a predetermined technical field.

In the information processing apparatus 1A, a configuration is adopted in which the phoneme distance table 132 is an inter-phoneme cost table created by a model trained using pair data of an erroneous word included in the recognition text of the speech acquired under a common condition and the corresponding correct word. Therefore, in the information processing apparatus 1A, in addition to the effects obtained by the information processing apparatus 1, it is possible to obtain an effect that speech recognition text correction can be performed more accurately on the speech recognition text acquired under specific conditions.

### Example of Implementation by Software

Some or all of the functions of the information processing apparatuses 1 and 1A (hereinafter, also referred to as “each of the above-described apparatuses”) may be implemented by hardware such as an integrated circuit (IC chip) or may be implemented by software.

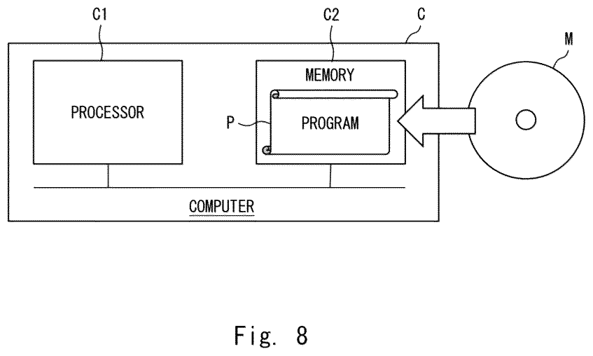

In the latter case, each of the above-described apparatuses is implemented by, for example, a computer that executes a command of a program that is software for implementing each function. An example of such a computer (hereinafter, referred to as a computer C) is illustrated in FIG. 8. FIG. 8 is a block diagram illustrating a hardware configuration of the computer C functioning as each of the above-described apparatuses.

The computer C includes at least one processor C1 and at least one memory C2. A program P for causing the computer C to operate as each of the above-described apparatuses is recorded in the memory C2. In the computer C, the processor C1 reads the program P from the memory C2 and executes the program P to implement each function of each of the above-described apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another apparatus. The computer C may further include an input/output interface for connecting input/output apparatuses such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

The program P can be stored and provided to a computer using any type of non-transitory computer readable media M. Non-transitory computer readable media M include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM, etc.). The program P may be provided to the computer C using any type of transitory computer readable media. Examples of transitory computer readable media include electric signals, optical signals, and electromagnetic waves. Transitory computer readable media can provide the program P to the computer C via a wired communication line (e.g. electric wires, and optical fibers) or a wireless communication line.

Each of the above-described functions of each of the above-described apparatuses may be implemented by a single processor provided in a single computer, may be implemented in cooperation with a plurality of processors provided in a single computer, or may be implemented in cooperation with a plurality of processors provided in a plurality of computers. The program for causing each of the above-described apparatuses to implement each of the above-described functions may be stored in a single memory provided in a single computer, may be stored in a distributed manner in a plurality of memories provided in a single computer, or may be stored in a distributed manner in a plurality of memories provided in a plurality of computers.

### Supplementary Matter 1

The present disclosure includes the technologies described in the following Supplementary Notes. However, the present disclosure is not limited to the technologies described in each of Supplementary Notes below, and various modifications can be made within the scope described in the claims.

### Supplementary Note 1

An information processing apparatus including: an acquisition means for acquiring speech recognition text obtained by converting speech into a text; an error detection means for inputting the speech recognition text and a prompt for detecting speech recognition erroneous words in the speech recognition text to a first large language model, and acquiring the erroneous words output from the first large language model; a phoneme distance calculation means for acquiring one or more phoneme sequences of reading of each of the erroneous words, and outputting word correction candidates in which a normalized phoneme distance between two phonemes of the phoneme sequence is equal to or less than a predetermined threshold; and a sentence correction means for inputting the erroneous word, the word correction candidates output based on the erroneous word, and a prompt for instructing to select a word correction candidate to replace the erroneous word to a second large language model, applying the word correction candidate output from the second large language model to the speech recognition text, and outputting a result.

### Supplementary Note 2

The information processing apparatus according to Supplementary Note 1, in which the phoneme distance calculation means acquires the phoneme sequence of the erroneous word using a word reading dictionary.

### Supplementary Note 3

The information processing apparatus according to Supplementary Note 1 or 2, in which the phoneme distance calculation means derives the phoneme distance using a phoneme distance table in which a distance between two phonemes is defined.

### Supplementary Note 4

The information processing apparatus according to any one of Supplementary Notes 1 to 3, in which the error detection means acquires information regarding a topic of the speech recognition text together with the erroneous word, and the phoneme distance calculation means narrows down the word correction candidate using the information.

### Supplementary Note 5

The information processing apparatus according to Supplementary Note 4, in which the sentence correction means selects the word correction candidate based on the information acquired by the error detection means, using the second large language model generated by Retrieval-Augmented Generation.

### Supplementary Note 6

The information processing apparatus according to any one of Supplementary Notes 1 to 5, in which in a case where there is no word correction candidate in which the normalized phoneme distance is equal to or less than a predetermined threshold, the phoneme distance calculation means outputs the word correction candidate having a smallest normalized phoneme distance.

### Supplementary Note 7

The information processing apparatus according to Supplementary Note 2, in which a technical term flag is added to the word reading dictionary, and the phoneme distance calculation means adds a weight to a word to which the flag is added in obtaining the phoneme distance.

### Supplementary Note 8

The information processing apparatus according to Supplementary Note 3, in which the phoneme distance table is an inter-phoneme cost table created by a model trained using pair data of an erroneous word included in recognition text of speech acquired under a common condition and a corresponding correct word.

### Supplementary Note 9

An information processing method including: acquiring speech recognition text obtained by converting speech into a text; inputting the speech recognition text and a prompt for detecting speech recognition erroneous words in the speech recognition text to a first large language model, and acquiring the erroneous words output from the first large language model; acquiring one or more phoneme sequences of reading of each of the erroneous words, and outputting word correction candidates in which a normalized phoneme distance between two phonemes of the phoneme sequence is equal to or less than a predetermined threshold; and inputting the erroneous word, the word correction candidates output based on the erroneous word, and a prompt for instructing to select a word correction candidate to replace the erroneous word to a second large language model, applying the word correction candidate output from the second large language model to the speech recognition text, and outputting a result.

### Supplementary Note 10

An information processing program causing a computer to execute processing, the processing including: processing of acquiring speech recognition text obtained by converting speech into a text; processing of inputting the speech recognition text and a prompt for detecting speech recognition erroneous words in the speech recognition text to a first large language model, and acquiring the erroneous words output from the first large language model; processing of acquiring one or more phoneme sequences of reading of each of the erroneous words, and outputting word correction candidates in which a normalized phoneme distance between two phonemes of the phoneme sequence is equal to or less than a predetermined threshold; and processing of inputting the erroneous word, the word correction candidates output based on the erroneous word, and a prompt for instructing to select a word correction candidate to replace the erroneous word to a second large language model, applying the word correction candidate output from the second large language model to the speech recognition text, and outputting a result.

### Supplementary Matter 2

The present disclosure includes the technologies described in the following Supplementary Notes. However, the present disclosure is not limited to the technologies described in each of Supplementary Notes below, and various modifications can be made within the scope described in the claims.

### Supplementary Note 21

An information processing apparatus including at least one processor, in which the at least one processor executes: acquisition processing of acquiring speech recognition text obtained by converting speech into a text; error detection processing of inputting the speech recognition text and a prompt for detecting speech recognition erroneous words in the speech recognition text to a first large language model, and acquiring the erroneous words output from the first large language model; phoneme distance calculation processing of acquiring one or more phoneme sequences of reading of each of the erroneous words, and outputting word correction candidates in which a normalized phoneme distance between two phonemes of the phoneme sequence is equal to or less than a predetermined threshold; and sentence correction processing of inputting the erroneous word, the word correction candidates output based on the erroneous word, and a prompt for instructing to select a word correction candidate to replace the erroneous word to a second large language model, applying the word correction candidate output from the second large language model to the speech recognition text, and outputting a result.

The information processing apparatus may further include a memory. The memory may store a program for causing the at least one processor to execute each type of the processing.

### Supplementary Note 22

The information processing apparatus according to Supplementary Note 21, in which in the phoneme distance calculation processing, the at least one processor acquires the phoneme sequence of the erroneous word using a word reading dictionary.

### Supplementary Note 23

The information processing apparatus according to Supplementary Note 21, in which in the phoneme distance calculation processing, the at least one processor derives the phoneme distance using a phoneme distance table in which a distance between two phonemes is defined.

### Supplementary Note 24

The information processing apparatus according to Supplementary Note 21, in which in the error detection processing, the at least one processor acquires information regarding a topic of the speech recognition text together with the erroneous word, and the phoneme distance calculation processing narrows down the word correction candidate using the information.

### Supplementary Note 25

The information processing apparatus according to Supplementary Note 24, in which in the sentence correction processing, the at least one processor selects the word correction candidate based on the information acquired in the error detection processing using the second large language model generated by Retrieval-Augmented Generation.

### Supplementary Note 26

The information processing apparatus according to Supplementary Note 21, in which in the phoneme distance calculation processing, in a case where there is no word correction candidate in which the normalized phoneme distance is equal to or less than a predetermined threshold, the at least one processor outputs the word correction candidate having a smallest normalized phoneme distance.

### Supplementary Note 27

The information processing apparatus according to Supplementary Note 22, in which a technical term flag is added to the word reading dictionary, and the phoneme distance calculation processing adds a weight to a word to which the flag is added in obtaining the phoneme distance.

### Supplementary Note 28

The information processing apparatus according to Supplementary Note 23, in which the phoneme distance table is an inter-phoneme cost table created by a model trained using pair data of an erroneous word included in recognition text of speech acquired under a common condition and a corresponding correct word.

### Supplementary Note 29

An information processing method causing at least one processor to execute: acquisition processing of acquiring speech recognition text obtained by converting speech into a text; error detection processing of inputting the speech recognition text and a prompt for detecting speech recognition erroneous words in the speech recognition text to a first large language model, and acquiring the erroneous words output from the first large language model; phoneme distance calculation processing of acquiring one or more phoneme sequences of reading of each of the erroneous words, and outputting word correction candidates in which a normalized phoneme distance between two phonemes of the phoneme sequence is equal to or less than a predetermined threshold; and sentence correction processing of inputting the erroneous word, the word correction candidates output based on the erroneous word, and a prompt for instructing to select a word correction candidate to replace the erroneous word to a second large language model, applying the word correction candidate output from the second large language model to the speech recognition text, and outputting a result.

### Supplementary Matter 3

The present disclosure includes the technologies described in the following Supplementary Notes. However, the present disclosure is not limited to the technologies described in each of Supplementary Notes below, and various modifications can be made within the scope described in the claims.

### Supplementary Note 31

An information processing method including: acquisition processing of acquiring, by at least one processor, speech recognition text obtained by converting speech into a text; error detection processing of inputting, by the at least one processor, the speech recognition text and a prompt for detecting speech recognition erroneous words in the speech recognition text to a first large language model, and acquiring the erroneous words output from the first large language model; phoneme distance calculation processing of acquiring, by the at least one processor, one or more phoneme sequences of reading of each of the erroneous words, and outputting word correction candidates in which a normalized phoneme distance between two phonemes of the phoneme sequence is equal to or less than a predetermined threshold; and sentence correction processing of inputting, by the at least one processor, the erroneous word, the word correction candidates output based on the erroneous word, and a prompt for instructing to select a word correction candidate to replace the erroneous word to a second large language model, applying the word correction candidate output from the second large language model to the speech recognition text, and outputting a result.

### Supplementary Note 32

The information processing method according to Supplementary Note 31, in which in the phoneme distance calculation processing, the at least one processor acquires the phoneme sequence of the erroneous word using a word reading dictionary.

### Supplementary Note 33

The information processing method according to Supplementary Note 31 or 32, in which the phoneme distance calculation processing, the at least one processor derives the phoneme distance using a phoneme distance table in which a distance between two phonemes is defined.

### Supplementary Note 34

The information processing method according to any one of Supplementary Notes 31 to 33, in which in the error detection processing, the at least one processor acquires information regarding a topic of the speech recognition text together with the erroneous word, and in the phoneme distance calculation processing, the word correction candidate is narrowed down using the information.

### Supplementary Note 35

The information processing method according to Supplementary Note 34, in which in the sentence correction processing, the at least one processor selects the word correction candidate based on the acquired information using the second large language model generated by Retrieval-Augmented Generation.

### Supplementary Note 36

The information processing method according to any one of Supplementary Notes 31 to 35, in which in the phoneme distance calculation processing, in a case where there is no word correction candidate in which the normalized phoneme distance is equal to or less than a predetermined threshold, the at least one processor outputs the word correction candidate having a smallest normalized phoneme distance.

### Supplementary Note 37

The information processing method according to Supplementary Note 32, in which a technical term flag is added to the word reading dictionary, and in the phoneme distance calculation processing, a weight is added to a word to which the flag is added in obtaining the phoneme distance.

### Supplementary Note 38

The information processing method according to Supplementary Note 33, in which the phoneme distance table is an inter-phoneme cost table created by a model trained using pair data of an erroneous word included in recognition text of speech acquired under a common condition and a corresponding correct word.

What is claimed is:

1. An information processing apparatus comprising:
at least one memory storing instructions, and
at least one processor configured to execute the instructions to;
acquire speech recognition text obtained by converting speech into a text;
input the speech recognition text and a prompt for detecting speech recognition erroneous words in the speech recognition text to a first large language model, and acquire the erroneous words output from the first large language model;
acquire one or more phoneme sequences of reading of each of the erroneous words, and output word correction candidates in which a normalized phoneme distance between two phonemes of the phoneme sequence is equal to or less than a predetermined threshold; and
input the erroneous word, the word correction candidates output based on the erroneous word, and a prompt for instructing to select the word correction candidate to replace the erroneous word to a second large language model, apply the word correction candidate output from the second large language model to the speech recognition text, and output a result.

2. The information processing apparatus according to claim 1, wherein the at least one processor is further configured to execute the instructions to acquire the phoneme sequence of the erroneous word using a word reading dictionary.

3. The information processing apparatus according to claim 1, wherein the at least one processor is further configured to execute the instructions to derive the phoneme distance using a phoneme distance table in which a distance between two phonemes is defined.

4. The information processing apparatus according to claim 1, wherein the at least one processor is further configured to execute the instructions to acquire information regarding a topic of the speech recognition text together with the erroneous word, and narrow down the word correction candidate using the information.

5. The information processing apparatus according to claim 4, wherein the at least one processor is further configured to execute the instructions to select the word correction candidate based on the acquired information, using the second large language model generated by Retrieval-Augmented Generation.

6. The information processing apparatus according to claim 1, wherein the at least one processor is further configured to execute the instructions to, in a case where there is no word correction candidate in which the normalized phoneme distance is equal to or less than a predetermined threshold, output the word correction candidate having a smallest normalized phoneme distance.

7. The information processing apparatus according to claim 2, wherein a technical term flag is added to the word reading dictionary, and the at least one processor is further configured to execute the instructions to add a weight to a word to which the flag is added in obtaining the phoneme distance.

8. The information processing apparatus according to claim 3, wherein the phoneme distance table is an inter-phoneme cost table created by a model trained by machine learning using pair data of an erroneous word included in recognition text of speech acquired under a common condition and a corresponding correct word.

9. An information processing method wherein
a computer
acquires speech recognition text obtained by converting speech into a text;
inputs the speech recognition text and a prompt for detecting speech recognition erroneous words in the speech recognition text to a first large language model, and acquires the erroneous words output from the first large language model;
acquires one or more phoneme sequences of reading of each of the erroneous words, and outputs word correction candidates in which a normalized phoneme distance between two phonemes of the phoneme sequence is equal to or less than a predetermined threshold; and
inputs the erroneous word, the word correction candidates output based on the erroneous word, and a prompt for instructing to select the word correction candidate to replace the erroneous word to a second large language model, applies the word correction candidate output from the second large language model to the speech recognition text, and outputs a result.

10. A non-transitory computer-readable medium storing an information processing program causing a computer to execute processing, the processing comprising:
processing of acquiring speech recognition text obtained by converting speech into a text;
processing of inputting the speech recognition text and a prompt for detecting speech recognition erroneous words in the speech recognition text to a first large language model, and acquiring the erroneous words output from the first large language model;
processing of acquiring one or more phoneme sequences of reading of each of the erroneous words, and outputting word correction candidates in which a normalized phoneme distance between two phonemes of the phoneme sequence is equal to or less than a predetermined threshold; and
processing of inputting the erroneous word, the word correction candidates output based on the erroneous word, and a prompt for instructing to select a word correction candidate to replace the erroneous word to a second large language model, applying the word correction candidate output from the second large language model to the speech recognition text, and outputting a result.
